(19) United States
(12) Patent Application Publication
(10) Pub. No.: US 2016/0216774 A1
(43) Pub. Date: Jul. 28, 2016

(54) Method for Generating a Cursor on an External Monitor Connected to a Handheld Computer

(71) Applicants: Ping-Shun Zeung, Taipei City (TW); Chung-Han Hsieh, Taipei City (TW); Szu-Wan Lu, Taipei City (TW)

(72) Inventors: Ping-Shun Zeung, Taipei City (TW); Chung-Han Hsieh, Taipei City (TW); Szu-Wan Lu, Taipei City (TW)

(73) Assignee: I/O INTERCONNECT INC., Taipei City (TW)

(21) Appl. No.: 14/862,312

(22) Filed: Sep. 23, 2015

Related U.S. Application Data
(63) Continuation-in-part of application No. 14/607,046, filed on Jan. 27, 2015.

(51) Int. Cl. G06F 3/038; G06F 3/14; G06F 3/0354

(52) U.S. Cl. CPC G06F 3/038; G06F 3/03543; G06F 3/14

(57) ABSTRACT

A method for generating operable cursor on a monitor connected to a smartphone is disclosed. The method includes the steps of: a) providing a cursor generator which receives a source video signal, outputs a generated video signal, and is also capable of connecting a mouse; b) operationally connecting the cursor generator between the monitor and the smartphone to receive the source video signal from the smartphone; c) generating a cursor into the source video signal; and d) outputting the generated video signal with the cursor to the monitor and sending a positional signal of the cursor to the smartphone.

### CROSS-REFERENCE TO RELATED APPLICATIONS

This application is a continuation-in-part of U.S. patent application Ser. No. 14/607,046, filed Jan. 27, 2015, now pending.

### BACKGROUND OF THE INVENTION

1. Technical Field

The invention relates to a connection of an external monitor and a handheld computer, particularly to cursor interaction between an external monitor and a handheld computer.

2. Related Art

Handheld computers, such as smartphones and tablets, have become essential for most people. As shown in FIG. 1, many users of handheld computers would prefer to connect their handheld computer 1 to an external monitor 2 (for example, a TV set or a display) that can serve as a larger display. Under this arrangement, however, a cursor will not normally appear on either the handheld computer 1 or the external monitor 2. Normally a cursor appears only when the handheld computer 1 is connected to a personal computer (for example, a desktop or a laptop computer) with a mouse or a touchpad.

TV sets and displays are not normally designed to be used with mouse or keyboards. Although most handheld computers are provided with a touchscreen, nevertheless, mouse and keyboard are still much more convenient to operate than a touchscreen. Until now, a user cannot use a mouse to operate his or her handheld computer 1 connected to the external monitor 2 due to lacking of a visible cursor. One of the way to “solve” this problem is to replace the external monitor with a personal computer with a mouse, but this is unsatisfactory due to the size of the display of a personal computer is typically much smaller than a typical TV set. If somehow users were allowed to operate a handheld computer 2 connecting a TV set by a mouse, it will be very convenient for users indeed. However, there is no solution on the market yet.

### SUMMARY OF THE INVENTION

An object of the invention is to provide a method for generating a cursor on an external monitor connected to a handheld computer, which allow users to operate a handheld computer with a mouse when the handheld computer is connected to an external monitor.

To accomplish the above object, the method of the invention includes the steps of: a) providing a cursor generator which receives a first video signal, and outputs a second video signal, and which is also capable of connecting to a mouse; b) operationally connecting the cursor generator between the external monitor and the handheld computer to receive the first video signal from the handheld computer; c) generating a cursor into the first video signal; and d) outputting the second video signal with the cursor to the external monitor and sending a positional signal of the cursor to the handheld computer.

### BRIEF DESCRIPTION OF THE DRAWINGS

FIG. 1 is a schematic view of a conventional arrangement of connecting a handheld computer to an external monitor;

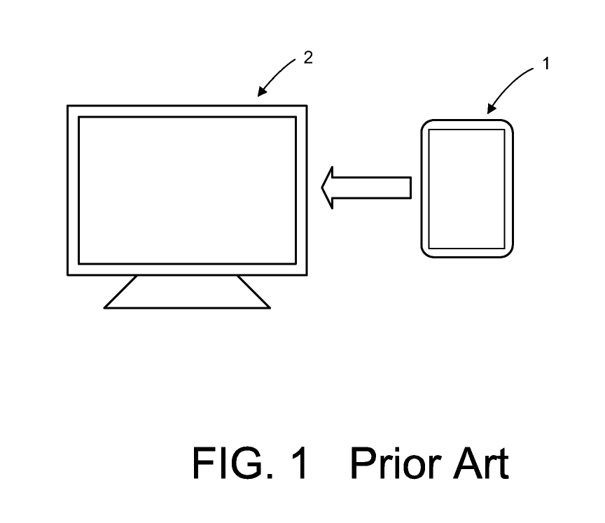

FIG. 2 is a schematic view of hardware arrangement of the invention; and

FIG. 3 is a flowchart of the method of the invention.

### DETAILED DESCRIPTION OF THE INVENTION

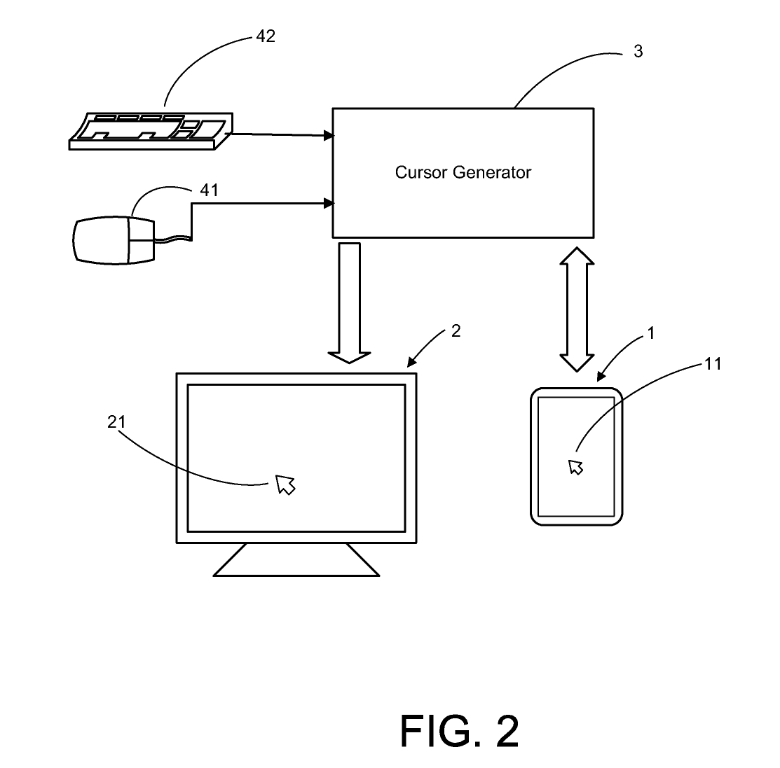

Please refer to FIG. 2. The invention provides a method for generating a cursor on an external monitor 2 connected to a handheld computer 1. The handheld computer 1 may be a smartphone or a tablet computer. The external monitor 2 may be a TV set or a display. A cursor generator 3 is between the handheld computer 1 and the external monitor 2, and receives a first video signal from the handheld computer 1 and outputs a second video signal to the external monitor 2, thus a screen picture of the handheld computer 1 can be transferred to the external monitor 2 through the cursor generator 3. Additionally, the cursor generator 3 is capable of connecting to a mouse 41 and a keyboard 42.

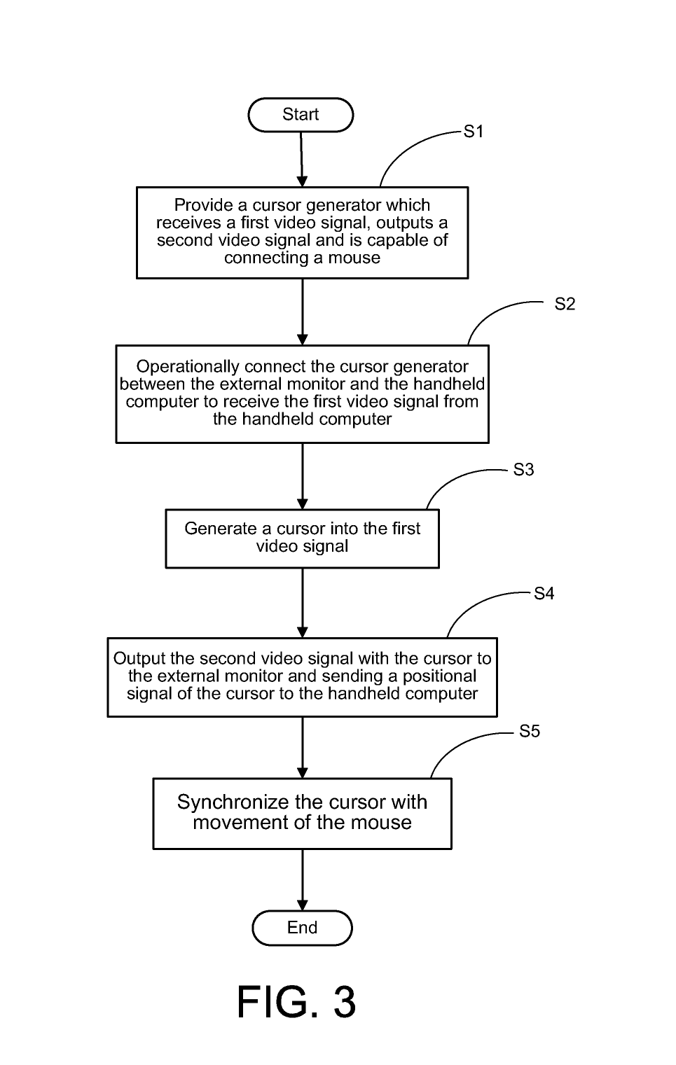

Please refer to FIG. 3, which shows a flowchart of the method of the invention. In step S1, a cursor generator 3 is provided as aforementioned, the cursor generator 3 receives a first video signal, outputs a second video signal, and is capable of connecting a mouse. In step S2, the cursor generator 3 is operationally connected between the external monitor 2 and the handheld computer 1 and is receiving the first video signal from the handheld computer 1. The connection between the handheld computer 1 and the cursor generator 3 may utilize, but not limited to, a USB (universal serial bus) cable and the connection between the cursor generator 3 and the external monitor 2 may utilize, but not limited to, an HDMI (high definition multimedia interface) cable. Of course, any other wired or wireless links are still possibly available.

In step S3, the cursor generator 3 generates a cursor into the first video signal from the handheld computer 1. Finally, in step S4, the cursor generator 3 outputs the second video signal with the cursor to the external monitor 2 and sends a positional signal of the cursor to the handheld computer 1. Thus, a screen picture of the handheld computer 1 can be displayed on the external monitor 2 and a cursor 21 is embedded in the screen picture of the external monitor 2. On the other hand, another cursor 11 will be shown on the handheld computer 1. And the two cursors 11, 21 are corresponding to each other.

A step S5 can be performed after the step S4, which is synchronizing the cursor 21 with movement of the mouse 41. Accordingly, the cursor 21 will be moved with the mouse 41 in tandem.

The invention offers great convenience to users and allows users to operate a handheld computer 1 effectively with a mouse 41 when the handheld computer 1 is connected to a TV set.

It will be appreciated by persons skilled in the art that the above embodiment has been described by way of example only and not in any limitative sense, and that various alterations and modifications are possible without departure from the scope of the invention as defined by the appended claims.

What is claimed is:

1. A method for generating a cursor on an external monitor connected to a handheld computer, comprising the steps of:
a) providing a cursor generator which receives a first video signal, outputs a second video signal, and is capable of connecting a mouse;
b) operationally connecting the cursor generator between the external monitor and the handheld computer to receive the first video signal from the handheld computer;
c) generating a cursor into the first video signal; and
d) outputting the second video signal with the cursor to the external monitor and sending a positional signal of the cursor to the handheld computer.

2. The method of claim 1, wherein the cursor generator is an independent module.

3. The method of claim 2, wherein the cursor generator is a dongle.

4. The method of claim 2, wherein the cursor generator is embedded in the external monitor.

5. The method of claim 1, further comprising a step e) after the step d): synchronizing the cursor with movement of the mouse.

6. The method of claim 1, wherein the external monitor is a TV set.

7. The method of claim 1, wherein the handheld computer is a smartphone or a tablet computer.
